(19) United States
(12) Patent Application Publication
(10) Pub. No.: US 2025/0326297 A1
(43) Pub. Date: Oct. 23, 2025

(54) Variable Curvature Lenslet Array for HUD Uniformity

(71) Applicant: Panasonic Automotive Systems Company of America, Division of Panasonic Corporation of North America, PEACHTREE CITY, GA (US)

(72) Inventors: MARC LATA, ATLANTA, GA (US); DANIEL AKINS, NEWNAN, GA (US); TRISTAN CRASTO, TROY, MI (US)

(21) Appl. No.: 19/096,026

(22) Filed: Mar. 31, 2025

Related U.S. Application Data
(60) Provisional application No. 63/637,465, filed on Apr. 23, 2024.

(51) Int. Cl. B60K 35/231

(52) U.S. Cl. CPC B60K 35/231; B60K 2360/23; B60K 2360/31; B60K 2360/336

(57) ABSTRACT

A head up display arrangement for a motor vehicle includes a picture generation unit having a plurality of light emitters conjunctively defining a first plane and each emitting light. A liquid crystal display defines a second plane that is nonparallel to the first plane. A plurality of lenses are disposed between the first plane and the second plane. Each lens passes light from a respective one of the light emitters to a respective zone of the liquid crystal display. Each lens has an optical characteristic that is dependent upon a distance between the respective one of the light emitters and the respective zone of the liquid crystal display. At least one mirror reflects light emitted by the liquid crystal display such that the reflected light is again reflected by a windshield of the motor vehicle to be visible by a human driver of the motor vehicle as a virtual image.

### CROSS-REFERENCE TO RELATED APPLICATIONS

This application claims benefit of U.S. Provisional Application No. 63/637,465, filed on Apr. 23, 2024, the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Then the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

A common issue encountered with heads-up displays is the “postcard” effect, which appears as a haze around the desired graphics when ambient lighting outside the vehicle is low. Local Dimming is a backlight solution that is being considered by many in the industry as a way to remove this postcard effect. Local Dimming removes the postcard effect by projecting an array of light sources onto the LCD plane. The brightness of each individual light source can be varied, enabling the backlight to be turned off completely for areas on the LCD that do not contain relevant information. The area illuminated by each LED is referred to as a “zone”.

However, this illumination arrangement runs into issues when the LCD is tilted relative to the plane of the backlight, since the zones will no longer be uniform in size or intensity on the LCD due to the divergence present in each zone's path. This tilt is a common way to prevent solar back-reflection and over-heating, and is also needed when implementing a tilted image plane.

One possible local dimming backlight consists of an array of light sources that are collimated by an array of lenslets and then projected onto an LCD screen. Because of the relative tilt between the plane of the backlight and the LCD, the distance between each lenslet and the LCD is not constant across the array.

The collimation of the light sources will necessarily have some finite cone angle. This means the area illuminated by the projected light will vary from zone to zone depending on the distance of the lens from the LCD if measures are not taken to correct for the relative tilt between the backlight and LCD.

FIG. 1 illustrates a known picture generation unit including a micro lens array (MLA) with constant power. Zone sizes vary across the area of the LCD.

### SUMMARY

The present invention may provide a head up display (HUD) system that includes an optical component having many lenslets of varying optical power fused into an array that enable a uniform projection of light emitting diode (LED) “zones” onto the liquid crystal display (LCD) of a heads-up display.

This invention solves the problem of inconsistent zone sizes and intensity non-uniformities that might be introduced by the tilt of the LCD screen relative to the backlight.

The present invention may provide a variable lens array that compensates for the uneven brightness that results from tilting of the LCD. In one embodiment, the farther from the LCD a lens of a micro lens array is, the narrower the angle of illumination that is provided by that lens.

In one embodiment, the invention comprises a head up display arrangement for a motor vehicle including a picture generation unit having a plurality of light emitters conjunctively defining a first plane and each emitting light. A liquid crystal display defines a second plane that is nonparallel to the first plane. A plurality of lenses are disposed between the first plane and the second plane. Each lens passes light from a respective one of the light emitters to a respective zone of the liquid crystal display. Each lens has an optical characteristic that is dependent upon a distance between the respective one of the light emitters and the respective zone of the liquid crystal display. At least one mirror reflects light emitted by the liquid crystal display such that the reflected light is again reflected by a windshield of the motor vehicle so as to be visible by a human driver of the motor vehicle as a virtual image.

In another embodiment, the invention comprises a picture generation unit for a head up display of a motor vehicle. The picture generation unit includes a plurality of light emitters conjunctively defining a first plane and each emitting light. A liquid crystal display defines a second plane that is nonparallel to the first plane. A plurality of lenses are disposed between the first plane and the second plane. Each lens passes light from a respective one of the light emitters to a respective zone of the liquid crystal display. Each lens has an optical characteristic that is dependent upon a distance between the respective one of the light emitters and the respective zone of the liquid crystal display.

In yet another embodiment, the invention comprises a picture generation unit for a head up display of a motor vehicle. The picture generation unit includes a plurality of light emitters conjunctively defining a first plane and each emitting light. A liquid crystal display defines a second plane that is nonparallel to the first plane. A plurality of lenses are disposed between the first plane and the second plane. Each lens passes light from a respective one of the light emitters to a respective zone of the liquid crystal display. Each lens has a beam angle that is inversely related to a distance between the respective one of the light emitters and the respective zone of the liquid crystal display.

### BRIEF DESCRIPTION OF THE DRAWINGS

A better understanding of the present invention will be had upon reference to the following description in conjunction with the accompanying drawings.

FIG. 1 is a schematic view of a picture generation unit including a micro lens array of the prior art.

FIG. 2 is a schematic view of one embodiment of a picture generation unit including a micro lens array of the present invention.

FIG. 3 is a schematic diagram of one embodiment of a head up display arrangement of the present invention including the picture generation unit of FIG. 2.

FIG. 4 is a flow chart of one embodiment of a picture generating method of the present invention.

### DETAILED DESCRIPTION OF THE PREFERRED EMBODIMENTS

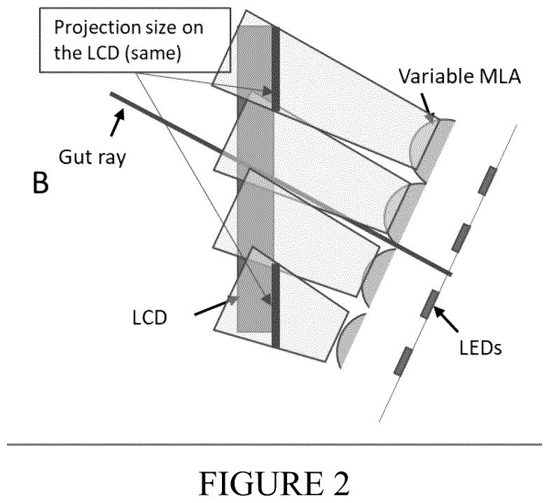

FIG. 2 illustrates one embodiment of a picture generation unit including a varied-power micro lens array (MLA). Zone sizes are equal or constant across the area of the LCD. The curvature of each lenslet may be different to compensate for the tilting of the LCD relative to the LEDs, resulting in more uniform zone size and intensity across the area of the LCD. As can be seen, a plane defined by the LCD is tilted or nonparallel to a plane defined by the LEDs.

Each lenslet in FIG. 2 has a distinct radius of curvature. Each lenslet may also have an aspheric profile. An aspheric lens is a lens whose surface profiles are not portions of a sphere or cylinder. The power, conic constant, and other higher-order curvature constants of each lenslet may vary with respect to one another while maximizing the uniformity of the illumination by the lens and source array on the surface of the LCD, Parameter boundaries may ensure the zones stay in the correct size range. Accordingly, the invention may achieve a more uniform illumination at the eyebox.

It is to be understood that FIG. 2 is not an accurate representation of the true geometry of the lenslets. Although the lenslets in FIG. 2 appear to have surface profiles that are portions of a sphere, the lenslets may actually have an aspheric profile and are generally not related. The size of the lenslets in FIG. 2 is meant to illustrate that the powers of the lenslets are different, thereby providing an even illumination despite the LEDs being at different distances from the LCD.

As can be seen in FIG. 2, each lenslet may produce a different respective light cone or beam angle. In this particular embodiment, the smaller the distance between the LED and the LCD, the larger the respective beam angle. That is, there may be an inverse or negative relationship between the distance between the LED and the LCD and the respective beam angle.

The present invention has been described herein as being implemented with individual lenses having different characteristics depending on their distance from the LCD. However, there are different implementations within the scope of the invention. For example, each individual LED may be fitted with a respective lens cap, with each lens cap having different optical properties depending on its distance from the LCD.

In another embodiment, LED intensity is different for every LED in the array to compensate for the LED's distance to the LCD. In yet another embodiment, the invention is implemented with reflector cones or other collimating optics. In a further embodiment, the invention is implemented with light pipes of different lengths to effectively reduce the distance between individual, respective lenslets and the LCD.

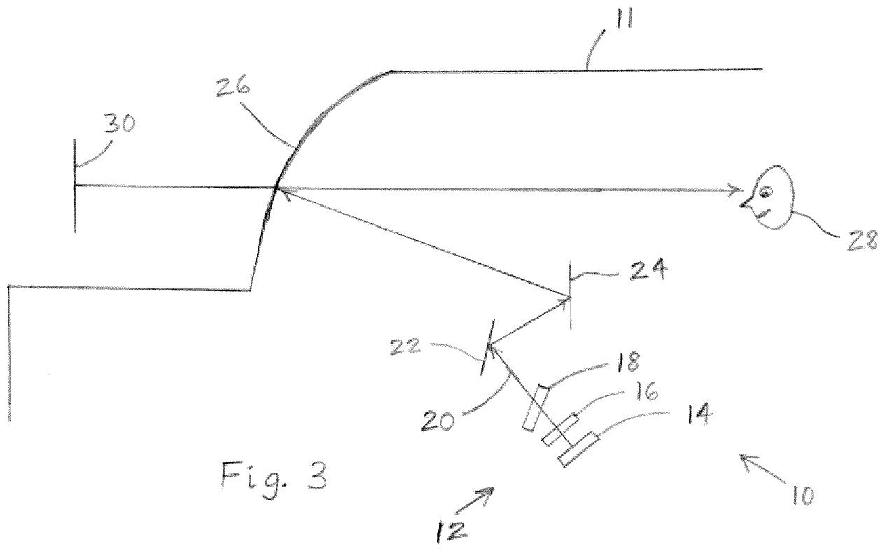

FIG. 3 illustrates one embodiment of a head up display arrangement 10 of the present invention including the picture generation unit 12 that is illustrated in FIG. 2. Head up display arrangement 10 is installed in a motor vehicle 11. Picture generation unit 12 includes LEDs 14, micro lens array 16 and LCD 18.

During use, a light field 20 (which is shown in FIG. 3 as a single ray for ease of illustration) from picture generation unit 12 may be reflected by lenses 22, 24 and windshield 26 such that light field 20 is visible to a human driver 28 as a virtual image 30.

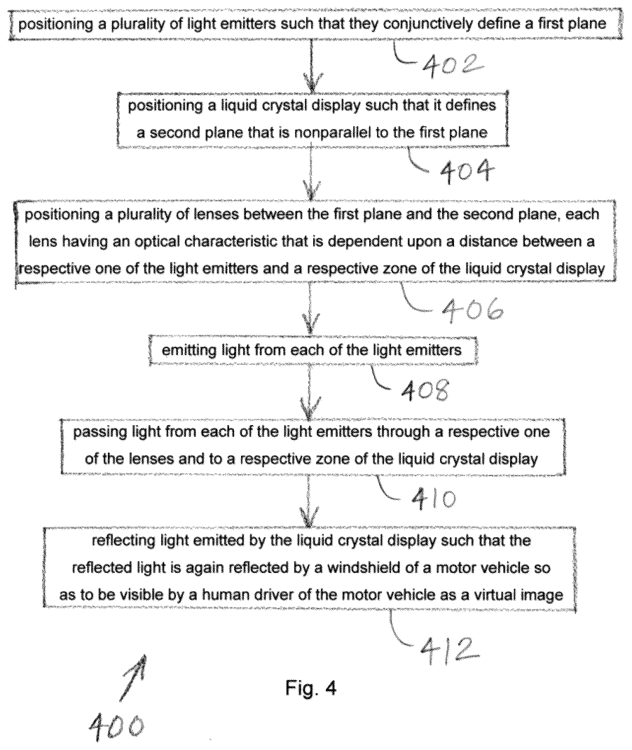

FIG. 4 is a flow chart of one embodiment of a picture generating method 400 of the present invention. In a first step 402, a plurality of light emitters are positioned such that they conjunctively define a first plane. For example, as shown in FIG. 2, the four LEDs may be aligned such that they conjunctively define a first plane.

In a next step 404, a liquid crystal display is positioned such that it defines a second plane that is nonparallel to the first plane. For example, as shown in FIG. 2, the LCD is positioned nonparallel to, or askew to, the plane defined by the four LEDs.

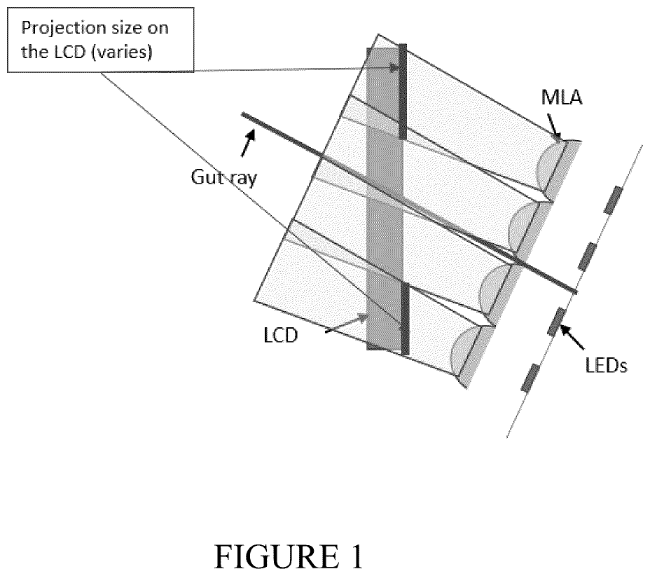

Next, in step 406, a plurality of lenses is positioned between the first plane and the second plane, each lens having an optical characteristic that is dependent upon a distance between a respective one of the light emitters and a respective zone of the LCD. For example, four lenslets are shown in FIG. 2 and are depicted as different portions of circles. Each lenslet may have a power that is dependent upon a distance between a respective one of the LEDs and a respective zone of the liquid crystal display. Thus, each lenslet may produce a different respective light cone or beam angle. In the particular embodiment shown in FIG. 1, the smaller the distance between the LED and the LCD, the larger the respective beam angle that is produced by the respective lenslet.

In step 408, light is emitted from each of the light emitters. For example, light may be emitted from each of the LEDs.

In a next step 410, light from each of the light emitters is passed through a respective one of the lenses and to a respective zone of the liquid crystal display. For example, light from each of the LEDs is passed through a respective one of the lenslets and to a respective zone of the LCD.

In a final step 412, light emitted by the liquid crystal display is reflected such that the reflected light is again reflected by a windshield of a motor vehicle so as to be visible by a human driver of the motor vehicle as a virtual image. For example, light emitted by the liquid crystal display is reflected by mirrors 22, 24 such that the reflected light is again reflected by windshield 26 of motor vehicle 11 so as to be visible by a human driver 28 of motor vehicle 11 as a virtual image 30.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood there from for modifications can be made by those skilled in the art upon reading this disclosure and may be made without departing from the spirit of the invention.

What is claimed is:

1. A head up display arrangement for a motor vehicle, the arrangement comprising:
a picture generation unit including:
a plurality of light emitters conjunctively defining a first plane and each being configured to emit light;
a liquid crystal display defining a second plane that is nonparallel to the first plane; and
a plurality of lenses disposed between the first plane and the second plane, each said lens being configured for passing light from a respective one of the light emitters to a respective zone of the liquid crystal display, each said lens having an optical characteristic that is dependent upon a distance between the respective one of the light emitters and the respective zone of the liquid crystal display; and
at least one mirror positioned and configured to reflect light emitted by the liquid crystal display such that the reflected light is again reflected by a windshield of the motor vehicle so as to be visible by a human driver of the motor vehicle as a virtual image.

2. The head up display arrangement of claim 1 wherein the lenses each have an aspheric profile.

3. The head up display arrangement of claim 1 wherein the lenses each have a different power.

4. The head up display arrangement of claim 1 wherein the lenses each have a different conic constant.

5. The head up display arrangement of claim 1 wherein the lenses comprise a means to substantially uniformly illuminate the liquid crystal display.

6. The head up display arrangement of claim 1 wherein the lenses each have a different curvature constant.

7. The head up display arrangement of claim 1 wherein the lenses each have a different radius of curvature.

8. A picture generation unit for a head up display of a motor vehicle, the picture generation unit comprising:
a plurality of light emitters conjunctively defining a first plane and each being configured to emit light;
a liquid crystal display defining a second plane that is nonparallel to the first plane; and
a plurality of lenses disposed between the first plane and the second plane, each said lens being configured for passing light from a respective one of the light emitters to a respective zone of the liquid crystal display, each said lens having an optical characteristic that is dependent upon a distance between the respective one of the light emitters and the respective zone of the liquid crystal display.

9. The picture generation unit of claim 8 wherein the lenses each have an aspheric profile.

10. The picture generation unit of claim 8 wherein the lenses each have a different power.

11. The picture generation unit of claim 8 wherein the lenses each have a different conic constant.

12. The picture generation unit of claim 8 wherein the lenses comprise a means to substantially uniformly illuminate the liquid crystal display.

13. The picture generation unit of claim 8 wherein the lenses each have a different curvature constant.

14. The picture generation unit of claim 8 wherein the lenses each have a different radius of curvature.

15. A picture generation unit for a head up display of a motor vehicle, the picture generation unit comprising:
a plurality of light emitters conjunctively defining a first plane and each being configured to emit light;
a liquid crystal display defining a second plane that is nonparallel to the first plane; and
a plurality of lenses disposed between the first plane and the second plane, each said lens being configured for passing light from a respective one of the light emitters to a respective zone of the liquid crystal display, each said lens having a beam angle that is inversely related to a distance between the respective one of the light emitters and the respective zone of the liquid crystal display.

16. The picture generation unit of claim 15 wherein the lenses each have an aspheric profile.

17. The picture generation unit of claim 15 wherein the lenses each have a different power.

18. The picture generation unit of claim 15 wherein the lenses each have a different conic constant.

19. The picture generation unit of claim 15 wherein the lenses comprise a means to substantially uniformly illuminate the liquid crystal display.

20. The picture generation unit of claim 15 wherein the lenses each have a different curvature constant.

21. The picture generation unit of claim 15 wherein the lenses each have a different radius of curvature.
